(19) United States
(12) Patent Application Publication
(10) Pub. No.: US 2026/0135253 A1
(43) Pub. Date: May 14, 2026

(54) SEPARATOR FOR ZINC ION BATTERY, METHOD FOR PREPARING SAME, AND ZINC ION BATTERY INCLUDING SAME

(71) Applicant: MURATA MANUFACTURING CO., LTD., Kyoto (JP)

(72) Inventors: Haiji HUANG, Shanghai (CN); Li WANG, Shanghai (CN); Yuli LI, Shanghai (CN); Kazumasa TAKESHI, Shanghai (CN)

(21) Appl. No.: 19/372,636

(22) Filed: Oct. 29, 2025

(30) Foreign Application Priority Data
Nov. 13, 2024 (CN) 2024116243613

(51) Int. Cl. H01M 50/44; H01M 4/38; H01M 4/50; H01M 10/36; H01M 50/403; H01M 50/431; H01M 50/443; H01M 50/489; H01M 50/491

(52) U.S. Cl. CPC H01M 50/44; H01M 4/38; H01M 4/50; H01M 10/36; H01M 50/403; H01M 50/431; H01M 50/443; H01M 50/489; H01M 50/491; H01M 2300/0002

(57) ABSTRACT

A separator for a zinc ion battery, a method for preparing same, and a zinc ion battery including same are provided. The separator includes a separator substrate including a fiber material and a filler dispersed in the fiber material in a form of particles, wherein the filler is an ammonium phosphate salt.

### CROSS REFERENCE TO RELATED APPLICATIONS

The present application claims priority to Chinese Patent Application No. 2024116243613, filed on Nov. 13, 2024, the entire disclosure of which is incorporated herein by reference.

### BACKGROUND

The present disclosure relates to the field of zinc ion batteries, and in particular, to a separator for a zinc ion battery, a method for preparing same, and a zinc ion battery comprising same.

Aqueous zinc ion batteries have attracted the attention of researchers and developers in the energy field due to their high safety and low costs. However, as zinc ion batteries have the problem of zinc dendrite puncture and contact with the positive electrode material leading to battery short circuit, a thicker separator is required to prevent zinc dendrite puncture. The thicker separator reduces the energy density of zinc ion batteries and has an adverse effect on the performance of the zinc ion batteries. Zinc ion battery separator materials used in the prior art include the following types: glass fiber, which has the problems of low tensile strength, easy crushing and dissolution after immersion in an acid-base neutral solution, and high costs; Celgard separator, which is a polymer material based on polypropylene, polyethylene, or the like and has poor wettability, and when zinc dendrites contact a cloth, they will cause the cloth to become fibrotic, thereby increasing the porosity of the separator, destroying the separator structure, causing the loss of separator function, and ultimately leading to the problem of short circuit; and non-woven fabrics, which have good wettability, but also have the problem of zinc dendrites contacting a cloth to cause fibrosis and ultimately short circuit. Therefore, the zinc ion battery separator materials used in the prior art cannot solve the problem of zinc dendrite growth and puncture without affecting battery performance.

In view of the existence of the described problems, a need exists, for example, to develop a separator for a zinc ion battery capable of preventing zinc dendrite puncture at a lower thickness.

### SUMMARY

The present disclosure relates to providing, in an embodiment, a separator for a zinc ion battery, a method for preparing same, and a zinc ion battery comprising same, so as to solve a problem that the separator for a zinc ion battery is relatively thick in order to prevent zinc dendrite puncture, which leads to a decrease in battery performance.

Another aspect of the present disclosure relates to providing, in an embodiment, a separator for a zinc ion battery, a method for preparing same, and a zinc ion battery comprising same, so as to solve a problem that one or both of the flexibility and wettability of separators for zinc ion batteries are poor, the separators are easy to dissolve after being soaked in an acid-base neutral solution, and the costs are high.

According to an aspect of the present disclosure, in an embodiment, provided is a separator for a zinc ion battery, wherein the separator comprises a separator substrate containing a fiber material and a filler dispersed in the fiber material in the form of particles, wherein the filler is an ammonium phosphate salt.

In an embodiment, the fiber material is a paper material, a non-woven fabric, or a glass fiber, preferably a kitchen paper.

In an embodiment, the filler is ammonium polyphosphate, diammonium phosphate, ammonium phosphate trihydrate, or any combination thereof.

In an embodiment, the loading amount of the filler in the fiber material is 0.001-0.25 mg/cm², and preferably 0.005-0.015 mg/cm².

In an embodiment, the porosity of the fiber material is 2.5-60%.

In an embodiment, the average particle size of the particles of the filler is 0.5-2.5 μm.

Another aspect of the present disclosure, in an embodiment, provides a method for preparing a separator for a zinc ion battery according to the described aspect of the present disclosure, including:
preparing the filler as a suspension;
covering a filter screen on the separator substrate including a fiber material;
coating the suspension on the separator substrate covered with the filter screen, dispersing the filler in the fiber material in a form of particles; and
removing the filter screen.

In an embodiment, the concentration of the suspension of the filler is 0.1-5 mg/mL, and preferably 0.2-0.5 mg/mL.

Yet another aspect of the present disclosure, in an embodiment, provides a zinc ion secondary battery, comprising: a positive electrode, a negative electrode, an electrolyte, and the separator for a zinc ion battery according to the described aspect of the present disclosure.

In an embodiment, the positive electrode active material of the positive electrode comprises manganese oxide, vanadium oxide, manganese vanadium oxide, a complex formed by vanadium oxide and an organic ligand, a metal element or ammonium, an organic positive electrode material, an MXene material, or any combination thereof; and/or the negative electrode active material of the negative electrode comprises metal zinc or a zinc alloy; and/or the electrolyte comprises a zinc salt.

In an embodiment, the positive electrode active material of the positive electrode is manganese dioxide, the negative electrode active material of the negative electrode comprises metal zinc, and the electrolyte comprises manganese sulfate and zinc sulfate.

According to the present disclosure, in an embodiment, by dispersing an ammonium phosphate salt filler in the form of particles in a fiber material used for a separator for a zinc ion battery, the growth of zinc metal dendrites in the zinc ion battery can be effectively inhibited, thereby allowing a separator having a lower thickness to be used, and improving the performance of the zinc ion battery.

### BRIEF DESCRIPTION OF THE FIGURES

The accompanying drawings, which form a part of the present application, are used to provide a further understanding of the present disclosure. The schematic examples of the present disclosure and the description thereof are used to explain the present disclosure, and do not form improper limits to the present disclosure. In the drawings:

FIG. 1 is a graph of the cycle performance of the zinc ion battery prepared in Example 1.

FIG. 2 is a graph of the cycle performance of the zinc ion battery prepared in Example 3.

FIG. 3 is a graph of the cycle performance of the zinc ion battery prepared in Comparative Example 1.

FIG. 4 is a graph of the cycle performance of the zinc ion battery prepared in Comparative Example 2.

### DETAILED DESCRIPTION

It should be noted that the examples of the present disclosure and the features in the examples can be combined with each other without conflict. Hereinafter, the present disclosure will be described in further detail including with reference to the examples according to an embodiment.

As described in the Background, conventional separators for zinc ion batteries are known to have problems such as a relatively high thickness in order to prevent zinc dendrite puncture, resulting in decreased performance of the battery, poor flexibility and/or wettability, being easy to dissolve after being soaked in an acid-base neutral solution, and high costs. In view of the such problems, the present application provides, in an embodiment, a separator for a zinc ion battery, wherein the separator comprises a separator substrate containing a fiber material and a filler dispersed in the fiber material in the form of particles, wherein the filler is an ammonium phosphate salt.

In the present disclosure, by dispersing an ammonium phosphate salt filler in the form of particles in a fiber material used for a separator for a zinc ion battery, the growth of zinc metal dendrites in the zinc ion battery can be effectively inhibited, thereby allowing a separator having a lower thickness to be used and improving the performance of the zinc ion battery, for example, prolonging the cycle life of the zinc ion battery and improving the capacity retention rate. An ammonium phosphate salt is used as the filler of the separator for a zinc ion battery, wherein phosphate ions can effectively inhibit the growth of zinc metal dendrites, and ammonium ions can buffer the acidic environment, thereby inhibiting the pH reduction in the zinc ion battery, and thus inhibiting the dissolution loss of a positive electrode material such as MnO₂. The ammonium phosphate salt also serves as a flame retardant in the separator, and can improve the safety of the battery. In addition, dispersing the ammonium phosphate salt in the fiber material in the form of particles as a filler can effectively reduce the porosity of the fiber material separator, thereby preventing zinc ions from dissolving in the separator, increasing the contact area between the metal and the separator, and leading to more uniform dispersion of electrolyte salt concentration.

In a preferred embodiment, the fiber material is a paper material, a non-woven fabric, or a glass fiber, and preferably kitchen paper.

The separator of the present disclosure can be a fiber separator material known in the prior art, such as a non-woven fabric or a glass fiber, and as stated above, the filler ammonium phosphate salt dispersed therein in the form of particles can effectively inhibit the growth of zinc metal dendrites, thereby allowing the use of a separator having a lower thickness and improving the performance of a zinc ion battery. Preferably, the present disclosure proposes to use a paper material, such as kitchen paper, as the separator material. The paper material, such as kitchen paper, has relatively low costs as a mature commercial product, and has good flexibility and wettability, so that after the paper material has been impregnated with the electrolyte, electrolyte components are evenly dispersed therein without agglomeration, and the paper material is easily adhered to the surfaces of the positive electrode and the negative electrode. In addition, the kitchen paper has a pattern of a highly ordered concave and convex shape, which is more beneficial to achieve uniform filling of the filler during coating of the filler. Therefore, using the described material as the separator is more advantageous for improving the performance of the zinc ion battery.

In a preferred embodiment, the filler is ammonium polyphosphate, diammonium phosphate, ammonium phosphate trihydrate, or any combination thereof.

The ammonium phosphate salt filler of the present disclosure can be any ammonium phosphate salt filler suitable for a zinc ion battery. Among these, as shown in the examples below, ammonium polyphosphate ((NH₄PO₃)ₙ, CAS: 68333-79-9), diammonium phosphate ((NH₄)₂HPO₄, CAS: 7783-28-0), ammonium phosphate trihydrate ((NH₄)₃PO₄·3H₂O, CAS: 25447-33-0), or any combination thereof are more beneficial for improving the performance of a zinc ion battery.

In a preferred embodiment, the loading amount of filler in the fiber material is 0.001-0.25 mg/cm², and preferably 0.005-0.015 mg/cm².

If the loading amount of the filler is too small, the improvement on the battery performance may be insufficient, and if the loading amount is too large, the filler may be unevenly distributed on the surface of the separator, resulting in an unstable loading amount and a decrease in consistency of the separator. Therefore, it is more advantageous to improve the performance of the zinc ion battery when the loading amount of the filler is within the described range.

In a preferred embodiment, the porosity of the fiber material is 2.5-60%.

In a preferred embodiment, the particles of the filler have an average particle size of 0.5-2.5 μm.

As described herein, in the present disclosure, the ammonium phosphate salt filler is dispersed in the form of particles in the separator of the fiber material, and the ammonium phosphate salt dispersed in the form of particles as a filler in the fiber material can effectively reduce the porosity of the separator of the fiber material. Preferably, when the porosity of the fiber material is within the described range, it is more advantageous to improve the performance of the zinc ion battery. For the filler in particle form, it is more advantageous to improve the performance of the zinc ion battery when its particle size is within a specific range. Specifically, if the particle size of the filler is too small, the filler may not be filled into the separator substrate effectively, and may fall into the battery structure and even cover the surface of the positive electrode sheet, which is not conducive to improving the battery capacity; and if the particle size of the filler is too large, the filler may merely stay on the surface of the separator substrate, and cannot penetrate into voids of the substrate, so that the surface of the separator is uneven, resulting in an unstable loading amount and poor consistency of the separator, and difficultly in achieving uniform deposition of zinc.

According to another aspect of the present disclosure, in an embodiment, provided is a method for preparing the described separator for a zinc ion battery, including:
preparing the filler as a suspension;
covering a filter screen on the separator substrate including a fiber material;
coating the suspension on the separator substrate covered with the filter screen, dispersing the filler in the fiber material in a form of particles; and
removing the filter screen.

The method for preparing the separator for a zinc ion battery of the present disclosure uses a suspension of a filler for wet coating. Because a suspension of the filler is used, some insoluble filler particles can be dispersed throughout the separator substrate. By covering a filter screen (preferably 200-1000 mesh stainless steel screen) on the separator substrate, uniform coating of the separator is achieved by uniform meshes on the filter screen. The filter screen is removed after coating, and excess filler may be removed along with the filter screen.

In a preferred embodiment, the concentration of the suspension of the filler is 0.1-5 mg/mL, and preferably 0.2-0.5 mg/mL.

When the concentration of the suspension of the filler is within a specific range, it is more advantageous to improve the performance of the zinc ion battery. Specifically, if the suspension concentration is too low, the the filler suspension can be lost due to sedimentation, and the filler added into the separator is insufficient, resulting in a larger separator porosity and a relatively poor preventive effect on the penetration of zinc dendrites into the separator. If the concentration of the solution is too high, too many filler particles are added into the separator, and protruding large particles may be formed on the surface of the separator, resulting in an uneven separator surface.

According to yet another aspect of the present disclosure, in an embodiment, provided is a zinc ion secondary battery, comprising: a positive electrode, a negative electrode, an electrolyte, and the described separator for a zinc ion battery.

In a preferred embodiment, the positive electrode active material of the positive electrode comprises manganese oxide, vanadium oxide, manganese vanadium oxide, a complex formed by vanadium oxide and an organic ligand, a metal element or ammonium, an organic positive electrode material, an MXene material, or any combination thereof; and/or the negative electrode active material of the negative electrode comprises metal zinc or a zinc alloy; and/or the electrolyte comprises a zinc salt.

The separator of the present disclosure may be applicable to various and suitable types of positive electrode, negative electrode, and electrolyte materials for zinc ion batteries. The positive electrode active material may be a manganese oxide MnₓO_{y}, for example, at least one of MnO, MnO₂, Mn₂O₃, Mn₃O₄, and Mn₅O₈; a vanadium oxide VₓO_{y}, for example, at least one of VO, VO₂, V₃O₅, V₃O₈, and V₅O₁₂ or vanadium metal; a manganese vanadium oxide MnₓV₂O₅·nH₂O, for example Mn_{0.15}V₂O₅·nH₂O; a vanadium oxide containing an organic ligand, a metal, and inserted ammonium, for example at least one of OrgₓV_{y}O_{z}·nH₂O (Org represents an organic ligand), MnₓV_{y}O_{z}·nH₂O, KₓV_{y}O_{z}·nH₂O, CaₓV_{y}O_{z}·nH₂O, NaₓV_{y}O_{z}·nH₂O, MgₓV_{y}O_{z}·nH₂O, AlₓV_{y}O_{z}·nH₂O, SₓV_{y}O_{z}·nH₂O, and (NH₄)ₓV_{y}O_{z}·nH₂O; an organic material, for example, metal organic frameworks (MOFs), conjugated organic frameworks (COFs), Prussian blue, and Prussian white; a polymer, for example, polyaniline, polypyrrole, and polythiophene; or an MXene material, for example, Ti₃C₂Tₓ. The negative electrode active material may be a zinc metal material, for example, at least one of zinc foil, zinc plate, zinc mesh, and zinc powder; a zinc-containing alloy material, for example, at least one of a zinc-copper alloy and a zinc-silver alloy. The electrolyte may be a zinc salt, for example, at least one of zinc sulfate, zinc chloride, zinc phosphate, and zinc triflate. The electrolyte may contain an additive, which is at least one of organic additives and salt additives.

In a preferred embodiment, the positive electrode active material of the positive electrode is manganese dioxide, the negative electrode active material of the negative electrode comprises metal zinc, and the electrolyte comprises manganese sulfate and zinc sulfate. Manganese ions are added to the electrolyte to supply manganese and inhibit dissolution of manganese. The reason for supplying manganese is to improve structural stability and electrochemical performance of the manganese-based positive electrode material. Incorporation of manganese sulfate as an additive into the electrolyte can improve the specific capacity, rate performance, and long-term stability of the zinc ion battery. Such an additive helps to maintain the crystallinity and crystal structure of the positive electrode material, and alleviates the dissolution of manganese in an aqueous solution, thereby improving the cycling stability and electrochemical performance of a battery. The reason for suppressing dissolution of manganese is to reduce dissolution of the positive electrode material during charging and discharging, and to extend the cycle life of the battery. The dissolution of manganese may cause loss of the active material, increase the turbidity of the electrolyte, and affect the performance and safety of the battery. By optimizing the composition of the electrolyte and using the additive, the dissolution of manganese can be suppressed, and the stability and the service life of the battery are improved. In conclusion, the purpose of supplying manganese in the electrolyte and suppressing the dissolution of manganese is to improve the electrochemical performance, cycle stability, and long-term performance of the zinc ion battery, and solve the challenge faced by manganese-based positive electrode material in battery applications. By optimizing the electrolyte and using the additive, the dissolution problem of manganese can be alleviated, and the overall performance of the battery is improved.

The present disclosure will be further described in detail including with reference to the following examples, which should not be construed as limiting the scope of protection of the present disclosure, according to an embodiment.

### EXAMPLE

Zinc ion batteries were prepared in the following examples.

### Preparation of Positive Electrode Sheet

Commercial nanometer manganese dioxide, conductive agent, and binder were taken at a weight ratio of 8/1/1, wherein an a phase nanometer manganese dioxide (Jiangsu Xianfeng Nanomaterial Technology Co., Ltd.) was selected as a positive electrode active material, the conductive agent was BP2000 (Carbot) or C45 conductive carbon black, and the binder was polyvinylidene fluoride (PVDF) (Solvay).

2.1 kg of PVDF was dissolved in N-methyl pyrrolidone (NMP) solvent, and 10.5% of a PVDF colloidal solution was prepared. Then, 16.8 kg of ground dry manganese dioxide nano powder was added, and the mixture was stirred and defoamed with a homogenizer until it was not agglomerated and was uniform. Then, 2.1 kg of the conductive agent BP2000 was added, and stirred and defoamed with a homogenizer until homogeneous permeation and dispersion. Then, an NMP solvent was added for dilution to a solid content of 40.93 wt % to 47.13 wt %, and stirring and defoaming by the homogenizer were continued until the slurry was in a flowable state.

Subsequently, the slurry was coated on a stainless steel foil current collector of SUS304, and dried in an oven of 90° C. for 5 minutes, so as to obtain a positive electrode sheet.

### Preparation of Negative Electrode Sheet

A 20 micrometer zinc foil was directly used as the negative electrode sheet.

### Preparation of Electrolyte

1000 ml of 2 M ZnSO₄-0.05 M MnSO₄ aqueous solution was formulated.

### Preparation of Separator

A suspension of ammonium polyphosphate in water was prepared. The kitchen paper was covered with a stainless steel screen (mesh of the stainless steel screen may be 24-50 mesh, 50-200 mesh, 200-5000 mesh, and preferably 50-200 mesh). 20 μL of the ammonium polyphosphate suspension was added dropwise to the kitchen paper, and coated by means of a blade coating method, so that the separator substrate fully absorbed the suspension and was fully wetted, and the separator substrate was air-dried. Then, the stainless steel screen was removed, and the separator substrate was hot-pressed at 80° C. to form a separator. The thickness of the separator was 43 μm.

### Assembly of Battery

A negative electrode battery shell, the negative electrode sheet, and the filled separator were sequentially assembled, 60 μl of the electrolyte was dropwise added, and then the positive electrode sheet, a gasket, an elastic sheet, and a positive electrode battery shell were sequentially assembled. The battery was transferred to a sealer and sealed, and stood for 30 minutes, so as to prepare a 2032 button battery for testing battery performance.

### Battery Performance Test

Charging and discharging cycles on a battery were performed on a Xinwei channel, and the capacity of the battery was tested, wherein constant-current discharging was set at 200 mA/g, constant-current charging was set at 200 mA/g, discharging was performed first and then charging was performed, and the voltage was in the range of 0.8-1.8 V.

### Example 1

Separators and zinc ion batteries were prepared according to the procedures described above by using different concentrations of the filler suspension. See Example 1-1 to Example 1-7 in Table 1 below.

### Example 2

Separators and zinc ion batteries were prepared according to the procedures described above by using different filler types. See Example 2-1 and Example 2-2 in Table 1 below.

### Example 3

The difference from Example 1 was that a glass fiber was used as the separator material (commercially available as Whatman GF/A separator) to prepare the zinc ion battery. See Table 1 below.

### Example 4

The difference from Example 1 was that the loading amount of the filler was out of the range of 0.001-0.25 mg/cm², and the concentration of the suspension of the filler was out of the range of 0.1-5 mg/mL. See Example 4-1 and Example 4-2 in Table 1 below.

### Example 5

The difference from Example 1 was that a zinc ion battery was prepared by using a nonwoven fabric as a separator material. See Table 1 below. The non-woven fabric was a wiping cloth for a BEMCOT® clean room (OZU corporation), and the material was 70% of long-fiber cellulose and 30% of long-fiber polyester.

TABLE 1

| | | | Separator | Separator | | | Loading | Average |
|---|---|---|---|---|---|---|---|---|
| | | | porosity | porosity | | Concentration | amount of | particle |
| | Separator | Separator | (before | (after | | of filler | filler | size of |
| Example | substrate | thickness | preparation) | preparation) | Filler | suspension | mg/cm² | filler |
| 1-1 | kitchen paper | 43 μm | 11.60% | 2.70% | ammonium | 0.1 mg/mL | 0.00255 | 2 μm |
| | | | | | polyphosphate | | | |
| 1-2 | kitchen paper | 43 μm | 11.60% | 2.90% | ammonium | 0.2 mg/mL | 0.00510 | 2 μm |
| | | | | | polyphosphate | | | |
| 1-3 | kitchen paper | 43 μm | 11.60% | 2.90% | ammonium | 0.5 mg/mL | 0.01275 | 2 μm |
| | | | | | polyphosphate | | | |
| 1-4 | kitchen paper | 43 μm | 11.60% | 3.20% | ammonium | 1.0 mg/mL | 0.02550 | 2 μm |
| | | | | | polyphosphate | | | |
| 1-5 | kitchen paper | 43 μm | 11.60% | 3.30% | ammonium | 2.0 mg/mL | 0.05100 | 2 μm |
| | | | | | polyphosphate | | | |
| 1-6 | kitchen paper | 43 μm | 11.60% | 3.90% | ammonium | 3.0 mg/mL | 0.07650 | 2 μm |
| | | | | | polyphosphate | | | |
| 1-7 | kitchen paper | 43 μm | 11.60% | 4.20% | ammonium | 5.0 mg/mL | 0.12750 | 2 μm |
| | | | | | polyphosphate | | | |
| 2-1 | kitchen paper | 43 μm | 11.60% | 2.90% | diammonium | 0.2 mg/mL | 0.00510 | 2 μm |
| | | | | | phosphate | | | |
| 2-2 | kitchen paper | 43 μm | 11.60% | 2.90% | ammonium | 0.2 mg/mL | 0.00510 | 2 μm |
| | | | | | phosphate | | | |
| | | | | | trihydrate | | | |
| 3 | glass fiber | 520 μm | 69.90% | 60.00% | ammonium | 0.2 mg/mL | 0.00510 | 2 μm |
| | | | | | polyphosphate | | | |
| 4-1 | kitchen paper | 43 μm | 11.60% | 2.90% | ammonium | 10.0 mg/mL | 0.25500 | 2 μm |
| | | | | | polyphosphate | | | |
| 4-2 | kitchen paper | 43 μm | 11.60% | 2.90% | ammonium | 0.03 mg/mL | 0.00077 | 2 μm |
| | | | | | polyphosphate | | | |
| 5 | non-woven | 110 μm | 61.70% | 4.50% | ammonium | 0.5 mg/mL | 0.00255 | 2 μm |
| | fabric | | | | polyphosphate | | | |

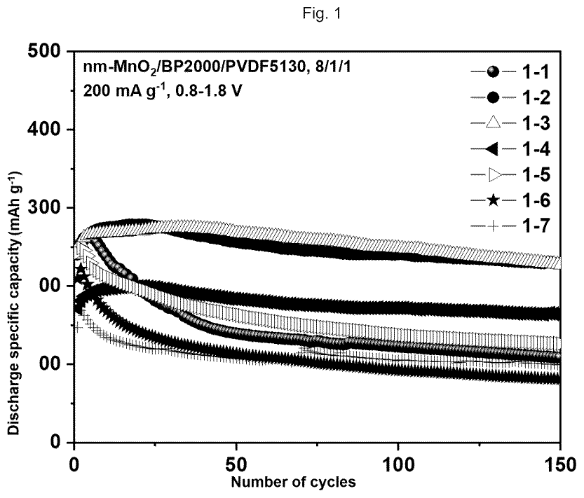

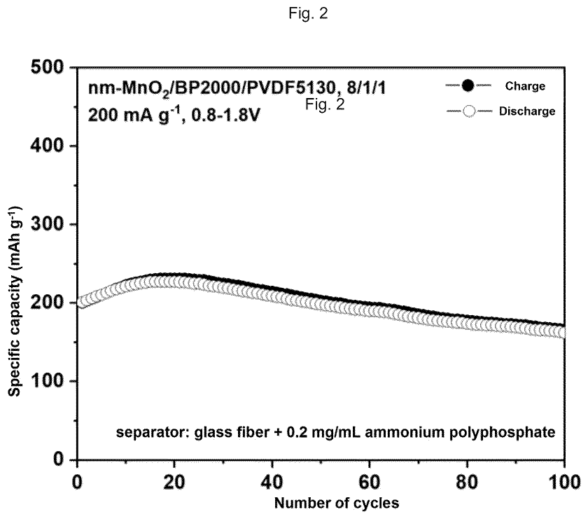

The zinc ion battery samples of the described examples were tested for battery performance, and the results were shown in Table 2 and FIGS. 1 and 2.

TABLE 2

| | | 100th | | |
|---|---|---|---|---|
| | Initial | cycle | | |
| | discharge | discharge | Maximum | Capacity |
| | specific | specific | specific | retention |
| | capacity | capacity | capacity | rate |
| Example | (mAh g⁻¹) | (mAh g⁻¹) | (mAh g⁻¹) | (%)* |
| 1-1 | 247.7 | 122.9 | 263.2 | 46.7 |
| 1-2 | 240.1 | 238.9 | 276.2 | 86.5 |
| 1-3 | 306.6 | 315.1 | 381.5 | 82.6 |
| 1-4 | 172.1 | 172.5 | 200.1 | 86.2 |
| 1-5 | 242.7 | 185.6 | 249.1 | 74.5 |
| 1-6 | 209.7 | 92.7 | 222.2 | 41.7 |
| 1-7 | 147.7 | 105.5 | 169.3 | 62.3 |
| 2-1 | 243.8 | 220.9 | 243.8 | 82.4 |
| 2-2 | 236.3 | 156.2 | 236.3 | 66.1 |
| 3 | 200.6 | 164.0 | 268.1 | 61.2 |
| 4-1 | 140.8 | 58.2 | 140.8 | 41.3 |
| 4-2 | 159.1 | 63.3 | 159.1 | 39.8 |
| 5 | 163.8 | 128.9 | 163.8 | 78.7 |

*capacity retention rate (%) = 100th discharge capacity/maximum discharge specific capacity × 100%

### Comparative Example 1

The difference from Example 1 was that no filler was added to the separator. See Table 3 below.

### Comparative Example 2

The difference from Example 1 was that a cellulose-type zinc ion battery separator was prepared by using carboxymethyl cellulose (CMC) and ammonium polyphosphate (APP) as raw materials, as shown in Table 3 below. The specific steps for preparing the separator were as follows: dissolving 2.00 g of CMC in 90 mL of deionized water, stirring for 30 min, dropwise adding 10.00 ml of an aqueous APP solution having a volume fraction of 5 mg/mL, and then stirring for another 30 min. The prepared aqueous solution of CMC-APP was sonicated and degassed for 30 min, and was left for gelation at room temperature for 3 days. The CMC-APP hydrogel thin sheet was pre-frozen at −20° C., and then freeze-dried at −20° C. for 24 h to obtain a CMC-APP aerogel sheet having a thickness of 1.2 mm. Subsequently, the sheet was rolled to a thin film having a thickness of 0.2 mm. Finally, it was cut into a separator having a diameter of 16 mm. In the separator, ammonium polyphosphate was formed as a constituent part of the separator substrate, rather than being dispersed in the separator substrate in the form of particles.

### Comparative Example 3

The difference from Comparative Example 1 was that a zinc ion battery was prepared by using a nonwoven fabric as a separator material. See Table 3 below.

### Comparative Example 4

The difference from Comparative Example 1 was that a zinc ion battery was prepared using a glass fiber as a separator material. See Table 3 below.

TABLE 3

| | | | Separator | Separator | | | Loading | Average |
|---|---|---|---|---|---|---|---|---|
| | | | porosity | porosity | | Concentration | amout of | particle |
| Comparative | Separator | Separator | (before | (after | | of filler | filler | size of |
| Example | substrate | thickness | preparation) | preparation) | Filler | suspension | mg/cm² | filler |
| 1 | kitchen paper | 43 μm | 11.60% | 2.90% | — | — | — | — |
| 2 | carboxymethyl | 200 μm | 15.60% | 3.30% | ammonium | 0.5 mg/mL | 0.01275 | 2 μm |
| | cellulose | | | | polyphosphate | | | |
| 3 | non-woven | 110 μm | 61.70% | 4.50% | — | — | — | — |
| | fabric | | | | | | | |
| 4 | glass fiber | 520 μm | 76.50% | 60.00% | — | — | — | — |

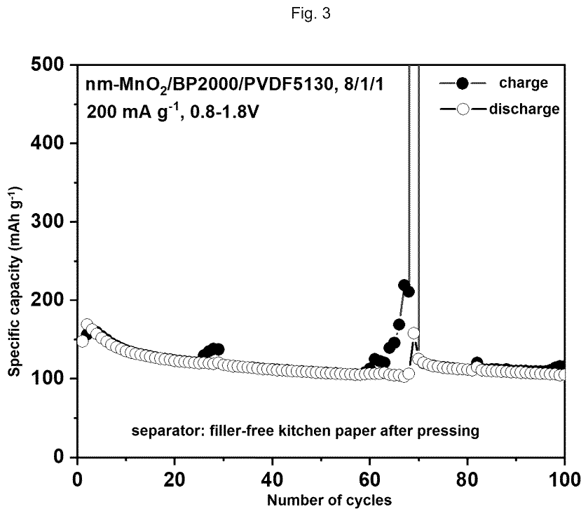

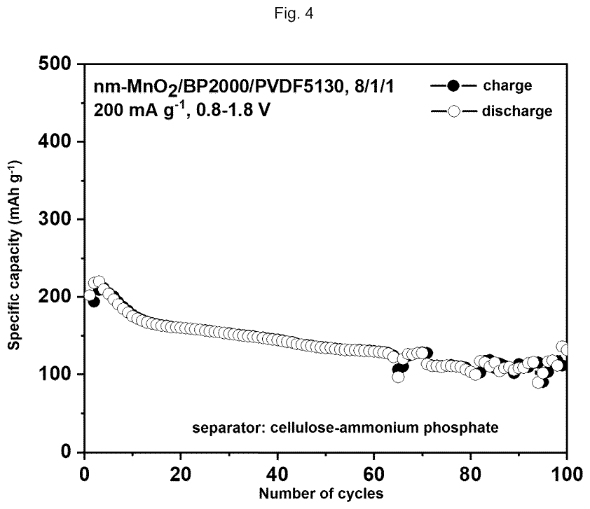

The zinc ion battery samples of the described Comparative Examples were tested for battery performance, and the results were shown in Table 4 and FIGS. 3 and 4.

TABLE 4

| | | 100th | | |
|---|---|---|---|---|
| | Initial | cycle | | |
| | discharge | discharge | Maximum | Capacity |
| | specific | specific | specific | retention |
| Comparative | capacity | capacity | capacity | rate |
| Example | (mAh g⁻¹) | (mAh g⁻¹) | (mAh g⁻¹) | (%) |
| 1 | 147.7 | — | 169.3 | — |
| 2 | 201.5 | 140.3 | 224.1 | 62.6 |
| 3 | 71.9 | 18.4 | 132.4 | 13.9 |
| 4 | 263.6 | 87.5 | 263.6 | 33.2 |

The battery sample of Comparative Example 1 was short-circuited before 100th cycle of charging/discharging, and thus the data of the discharge specific capacity and the capacity retention rate of 100th cycle were not obtained.

It can be determined from the test results that the described examples of the present disclosure achieve the following technical effects:

As can be determined by comparing Examples 1-1 to 1-7 with Comparative Examples 1, Example 5 and Comparative Example 3 as well as Example 3 and Comparative Example 4, the separators for a zinc ion battery comprising a separator substrate comprising a fiber material and an ammonium phosphate salt filler dispersed in the fiber material in form of particles of the present disclosure improved the capacity performance of the zinc ion battery compared to separators without the ammonium phosphate salt filler. The battery in Comparative Example 1 was short-circuited at the 70th cycle test, referring to FIG. 3. In addition, the reason for the initial discharge capacity and the maximum discharge capacity in Comparative Example 4 being superior to those in Example 3 is that the filler may slow down the ion transmission, resulting in a relatively low initial capacity. However, as the cycle proceeded, the capacity retention rate of Example 3 was significantly better than that of Comparative Example 4.

By comparing Example 1-3 with Comparative Example 2, it can be determined that at same amount of filler, the separator for a zinc ion battery comprising a separator substrate comprising a fiber material and an ammonium phosphate salt filler dispersed in the fiber material in form of particles of the present disclosure improved the capacity performance of the zinc ion battery compared to a cellulose type separator comprising an ammonium phosphate salt dissolved therein.

By comparing Example 1-2 and Example 3 as well as Example 1-3 and Example 5, respectively, it can be determined that using the preferred kitchen paper as a separator substrate at same amount of filler was beneficial for further improving the capacity performance of the zinc ion battery.

By comparing Examples 1-1 to 1-7 (especially Examples 1-2 and 1-3) and Examples 4-1 and 4-2, it can be determined that when the loading amount of the filler in the fiber material was 0.001-0.25 mg/cm², and preferably 0.005-0.015 mg/cm², the capacity performance of the zinc ion battery was further improved. And when the concentration of the suspension of the filler was 0.1-5 mg/mL, and preferably 0.2-0.5 mg/mL, it was advantageous to further improve the capacity performance of the zinc ion battery.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A separator for a zinc ion battery, the separator comprising: a separator substrate including a fiber material and a filler dispersed in the fiber material in a form of particles, wherein the filler is an ammonium phosphate salt.

2. The separator for a zinc ion battery according to claim 1, wherein the fiber material is a paper material, a kitchen paper material, a non-woven fabric or a glass fiber.

3. The separator for a zinc ion battery according to claim 1, wherein the filler is ammonium polyphosphate, diammonium phosphate, ammonium phosphate trihydrate, or any combination thereof.

4. The separator for a zinc ion battery according to claim 1, wherein a loading amount of the filler in the fiber material ranges from 0.001 mg/cm² to 0.25 mg/cm².

5. The separator for a zinc ion battery according to claim 1, wherein a porosity of the fiber material ranges from 2.5% to 60%.

6. The separator for a zinc ion battery according to claim 1, wherein an average particle size of the particles of the filler ranges from 0.5 μm to 2.5 μm.

7. A method for preparing the separator for a zinc ion battery, the method comprising:
1) preparing a filler as a suspension, wherein the filler is an ammonium phosphate salt;
2) covering a filter screen on a separator substrate including a fiber material;
3) coating the suspension on the separator substrate covered with the filter screen, dispersing the filler in the fiber material in a form of particles; and
4) removing the filter screen.

8. The method according to claim 7, wherein a concentration of the suspension of the filler is 0.1 mg/ml to 5 mg/mL.

9. A zinc ion battery, comprising:
a positive electrode,
a negative electrode,
an electrolyte, and
the separator for a zinc ion battery according to claim 1.

10. The zinc ion battery according to claim 9, wherein one or more of the positive electrode active material of the positive electrode comprises manganese oxide, vanadium oxide, manganese vanadium oxide, a complex formed by vanadium oxide and an organic ligand, a metal element, or ammonium, an organic positive electrode material, an MXene material, or any combination thereof; the negative electrode active material of the negative electrode comprises metal zinc or a zinc alloy; and the electrolyte comprises a zinc salt.

11. The zinc ion battery according to claim 9, wherein the positive electrode active material of the positive electrode is manganese dioxide, the negative electrode active material of the negative electrode comprises metal zinc, and the electrolyte comprises manganese sulfate and zinc sulfate.
